(19) United States
(12) Patent Application Publication
(10) Pub. No.: US 2009/0297714 A1
(43) Pub. Date: Dec. 3, 2009

(54) FLUSH PIGMENT FOR SOLID INKJET INK

(75) Inventors: Raymond W. WONG, Mississauga (CA); Peter G. ODELL, Mississauga (CA); C. Geoffrey ALLEN, Waterdown (CA); Rina CARLINI, Oakville (CA)

Correspondence Address: OLIFF & BERRIDGE, PLC., P.O. BOX 320850, ALEXANDRIA, VA, 22320-4850, US

(73) Assignee: XEROX CORPORATION, Norwalk, CT (US)

(21) Appl. No.: 12/131,356

(22) Filed: Jun. 2, 2008

(51) Int. Cl. C09D 11/02; B05D 5/00

(52) U.S. Cl. 427/256; 106/31.6

(57) ABSTRACT

The present disclosure provides for the process for preparing a solid inkjet ink using a pigment flush. One process includes applying a first mixing step to a pigment and a flushing agent to flush the pigment from am aqueous phase to a non-aqueous phase to form a pigment dispersion, adding at least one other ink ingredient, and incorporating the other ink ingredient in the pigment dispersion by applying a second mixing step to form a solid inkjet ink. Another process disclosed includes adding at least one ink ingredient directly to a pigment dispersion and mixing by applying a high shear mixer.

### BACKGROUND

The present disclosure is generally directed to inks, for example, solid inkjet inks. Moreover, the present disclosure is directed to the preparation of inks, especially solid inkjet inks that can be used in various printing processes such as thermal inkjet and acoustic inkjet processes.

In an acoustic or piezoelectric inkjet system, ink droplets are propelled to the recording medium by means of a piezoelectric oscillator. In such a system, a recording signal is applied to a recording head containing the piezoelectric oscillator, causing droplets of the ink to be generated and subsequently expelled through the printhead in response to the recording signal to generate an image on the recording medium. In this printing system, a recording signal is converted into a pulse by a signal processing means, such as a pulse converter, and then applied to the piezoelectric oscillator. A change in pressure on the ink within an ink chamber in the printhead caused by the recording signal results in droplets of ink being ejected through an orifice to a recording medium. Such an inkjet system is described in more detail, for example, in U.S. Pat. No. 4,627,875, the disclosure of which is totally incorporated herein by reference.

Thermal inkjet printing processes are described in more detail, for example, in U.S. Pat. Nos. 5,169,437 and 5,207,824, the disclosures of which are totally incorporated herein by reference.

In these and other inkjet recording processes, it is necessary that the ink being used meet various stringent performance characteristics. These performance characteristics are generally more stringent than those for other liquid ink applications, such as for writing instruments (a fountain pen, felt pen, and the like).

Further, there are many requirements for the liquid compositions including the above-described inks for inkjet recording, and specific examples thereof include. (1) no clogging of nozzles of inkjet recording heads; (2) superior ejection stability and frequency responsiveness; (3) good recovery of smooth ink ejection after residing in printhead for a long time, such as greater than two weeks; (4) no generation of precipitates even after long-term storage; (5) no corrosion-deterioration of members, such as the recording heads, which contact therewith; (6) provision of favorable printing quality; (7) safety and no unpleasant odor; and the like.

Various inks for inkjet printing processes are known in the art. For example, various inkjet inks are disclosed in U.S. Pat. Nos. 4,737,190 and 5,156,675.

Although numerous inkjet inks are presently available, they generally do not meet all of the above-described requirements, while also providing excellent print quality on plain paper. In particular, the inks generally used in inkjet printing processes, while producing acceptable print quality, do not produce the high print quality that is achieved by using dry toner compositions, such as in electrostatographic imaging processes.

A need continues to exist in the inkjet industry for improved inkjet inks, and processes for producing the same, that satisfy the above-described requirements while providing high quality prints on a wide variety of recording media, including plain paper. Although some currently available inkjet inks may provide waterfast images with better substrate latitude, the inks are unacceptable in that they generally smear and have poor latency and maintainability characteristics. In addition, such inks are generally difficult to manufacture. Thus, there remains a need in the inkjet ink industry for improved black and colored inks that can be easily prepared and can be obtained at a lower cost.

One type of inkjet ink is a solid inkjet ink, herein referred to as an SIJ ink, that contain pigments. Pigments are insoluble, fine particle size materials used in a number of applications including ink formulations, coatings, paints and the like to provide color, to hide substrates, to modify the properties of coatings, and to modify the performance properties of films.

Pigments are generally produced in an aqueous medium. One of the steps in the manufacture of pigments is precipitation from water. After precipitating the pigment, the pigment/water slurry is then filtered in a filter press to concentrate the pigment and to form a press cake. The press cake is either dried to obtain a dry pigment, or “flushed” to transfer the pigment particles from the aqueous phase to a non-aqueous resin phase commonly referred to as a “flushed color”. In the resulting flushed color state, the pigment particles are kept in a paste-like state for ultimate use in inks and coatings, for example.

The current pigmented SIJ ink preparation process uses pigment in its finished dry form as colorant. The pigment in the dry form is harder to disperse owing to the formation of pigment agglomerates and aggregates during the pigment's drying stage. The pigment generally needs to be wetted with a dispersing agent to form a pigment dispersion before being mixed with other ink ingredients under a high shearing process to form an ink. Unfortunately, the current SIJ ink preparation process can consume a lot of energy to disperse the dried powder pigment in various SIJ ink media.

### SUMMARY

In order to solve the above-identified problems, this disclosure describes the use of a pigment flush as a color dispersion for an SIJ ink. Generally, flushing is the direct transfer of pigments in an aqueous phase to an oil or non-aqueous phase without intermediate drying. A pigment flush prepared, for example, through an aqueous press cake, can often have finer particle size and better color strength than its dried pigment analog. The preparation of pigment dispersions by using a pigment flush is more economical than preparing an SIJ ink from dried pigment. The tedious, strenuous and slow process of grinding and reducing a dried pigment's particle size can be reduced or eliminated.

Generally, flushing is the direct transfer of pigments in an aqueous phase to an oil or non-aqueous phase without intermediate drying. Flushing of the pigment is carried out by intensely mixing a press cake with an ink oil or a flushing varnish. A “flushing varnish” is an ink oil containing a resin dissolved therein. The oil and/or flushing varnish is often referred to as a “flushing agent.”

The present disclosure provides for a process for preparing SIJ inks using a pigment flush. The process involves using a pigment flush as a color pigment pre-dispersion for the preparation of an SIJ ink.

### EMBODIMENTS

In an embodiment, a process for preparing a solid inkjet ink, comprises applying a first mixing step to a pigment and a flushing agent to flush the pigment from an aqueous phase to a non-aqueous phase to form a pigment dispersion; adding one or more ink ingredients to the pigment dispersion; and applying a second mixing step to the pigment dispersion to incorporate the pigment dispersion with the one or more ink ingredients.

Pigments at the press cake stage of manufacture have a particle size that is more suitable for maximum ink gloss and color strength in SIJ ink formulations than pigments in their finished dry form. Accordingly, flushed pigments produced without first drying the pigment are preferred colorants for SIJ ink formulations.

The press cake is flushed at a high temperature, for example 100° C. to 150° C., transferring the pigment particles from an aqueous phase to a non-aqueous phase to create a pigment dispersion. Generally, flushing is the direct transfer of pigments in an aqueous phase to a non-aqueous phase without intermediate drying. Flushing is carried out by intensely mixing the press cake with a flushing agent. The flushing agent can be a resin, for example, a triamide resin or a glycerol ester of a hydrogenated rosin, or mixtures thereof.

During the flushing process, in addition to a flushing agent, small amounts of flushing aids, such as surfactants, volatile polar vehicles, dispersants or polymers, alone or in combination, can also be added to the press cake to enhance the transfer of the pigment from aqueous phase to non-aqueous phase. The surfactants can be among known commercial surfactants, such as, Brij 76 and polyethylene glycol octadecyl ether, which can be obtained from ICI America Inc. Other dispersants are, for example, PETROLITE® WB-17 (a bis-urethane), OLOA® 11000 (a polyisobutylene succinimide that is described in U.S. Pat. No. 6,858,070), and a dispersant from the Solsperse® hyperdispersant series from Lubrizol can also be used. Additionally, any other commonly used pigment dispersant for non-aqueous pigment dispersions can be added during the flushing to enhance the dispersion of the pigment in the non-aqueous phase. Further examples of addition flushing aids are provided in the examples and are also discussed below.

The first mixing step flushes a pigment from an aqueous phase to a non-aqueous phase to form a pigment dispersion. The mixing can be achieved by high torque mixing or by high shear mixing.

High torque apparatuses include, for example, kneaders, a Kady® mill, a Ross X series mixer, various high shear homogenizers, for example, an IKA® Ultra Turrax T50 Homogenizer equipped with appropriate dispersing elements, sigma-blade mixers, an agitated vessel and the like. A high torque is required due to the high viscosity of the high pigment loading in resin. The apparatus used in high torque mixing can have a speed of, for example, from about 2,000 rpm to about 15,000 rpm. For high viscosity materials, the tip speed can be slowed and the torque increased, as is known in the art. The high torque mixing can have a tip speed of, for example, about 11,000 feet per minute. Lower speeds and greater torque can be achieved by methods known in the art.

High shear mixing can also be used to flush a pigment from an aqueous phase to a non-aqueous phase to form a pigment dispersion. In embodiments, the dispersing elements of a high shear mixer can have a peripheral speed of, for example, about 10 to about 50 m/s, or more specifically, a peripheral speed of about 20 to about 25 m/s. In addition, the high shear mixing can have increased torque as well, and the peripheral speed can be adjusted by known methods.

During the first mixing step, the kinetic energy that is generated keeps the resin melted, disperses the pigment, and separates the water from the press cake. The temperature of the pigment dispersion as a result of the heat generated from the mixing is about 100° C. to about 150° C., more specifically about 120° C. to about 140° C. The first mixing step, depending on the nature of the ingredients added, can be allowed to continue for several minutes to several hours, such as from about 15 minutes to about 4 hours, more specifically, from about 30 minutes to about 2 hours. The temperature of the mixture in the first mixing step can also be regulated such as by the use of a refrigerated heating circulator bath, a cold gun air coolant system, and the like. The heat generated by the mixing evaporates most of the water. Optionally, more water can be removed by, for example, vaporization, evaporation, decantation, centrifuigation or other means. With the removal of most of the water, the resulting pigment is now dispersed with the resin and can easily be mixed with one or more ink ingredients to form an SIJ ink. This process thus avoids the tedious and sometimes costly process of breaking down the pigmented aggregates that can form during the drying stage of the pigment making process.

Next, at least one other ink ingredient is added to the pigment dispersion. The other ink ingredients can be, for example, a wax, a colorant, or a resin, or mixtures or combinations thereof. The resin could be, for example, a triamide resin, a bis-urethane resin, or a rosin ester.

After one or more ink ingredients are added to the pigment dispersion, a second mixing step is performed to form an SIJ ink. In the second mixing step the pigment dispersion is mixed with a high-speed rotor-stator, such as an IKA® Ultra Turrax T50 Homogenizer, which can generate heat. The temperature of the pigment dispersion as a result of the heat generated from the mixing is about 100° C. to about 150° C., more specifically about 120° C. to about 140° C. The second mixing step, depending on the nature of the ingredients added, can be allowed to continue for several minutes to several hours, such as from about 5 minutes to about 4 hours, more specifically, from about 15 minutes to about 1 hour. The temperature of the mixture in the second mixing step can also be regulated such as by the use of a refrigerated heating circulator bath, a cold gun air coolant system, and the like.

In a first embodiment, any press cake from commercial pigment manufacturers can be used. For example, pigment press cakes from vendors such as Sun Chemical Corporation, Clariant Corporation and Apollo Colors Inc. may be employed. Such pigment press cakes may, for example, have pigment loadings at about 20 to about 50 percent dispersed in water. Other pigment press cakes include, but are not limited to, pigment press cakes having pigment loadings at about 10 to about 80 percent, about 20 to about 60 percent, or about 30 to about 40 percent dispersed in water,

Examples of aqueous pigment press cakes from Apollo Colors Inc. include those from the Aquarius, Gemini, Mercury, Neptune and Pegasus series, and include, for example, Rubine Red Yellow Shade, Rubine Red Blue Shade, Phthalo Blue, Red Lake C, AAOT Yellow, AAA Yellow, AAMX Yellow, 2B Red Yellow Shade, Red Lake C, Orange 46, Rubine Red, Diarylide Yellow, Phthalo Blue G, Diarylide Yellow Semi-Trans and Diarylide Yellow Transparent. Examples of aqueous high solids press cakes from Sun Chemical Corporation include those in the Sunsperse® series, such as Carbazole Violet, Diarylide Yellow AAOT, Diarylide Orange DNA, Quinacridone Magenta, and Phthalocyanine Green.

The pigment press cake may contain a variety of pigments and is not limited to any single pigment. Any pigment or colorant can be used. For example, colorants or pigments as used herein include pigment, dye, mixtures of pigment and dye, mixtures of pigments, mixtures of dyes, and the like. For simplicity, the term “colorant” as used herein is meant to encompass such colorants, dyes, pigments, and mixtures, unless specified as a particular pigment or other colorant component. In embodiments, the colorant comprises a pigment, a dye, and mixtures thereof, carbon black, magnetite, black, cyan, magenta, yellow, red, green, blue, orange, violet, and brown pigments and dyes, and mixtures thereof. It is to be understood that other useful colorants will become readily apparent based on the present disclosures.

In addition to aqueous press cakes, other types of press cakes can be used. For example, mixed aqueous/solvent press cakes such as those press cakes containing a water/acetone mix or a water/ethyl acetate mix can be used. Further examples include solvent-based press cakes, such as alkyd oils or soya oils, or hydrocarbon-based press cakes.

In general, useful colorants include Paliogen Violet 5100 and 5890 (BASF), Normandy Magenta RD-2400 (Paul Uhlrich), Permanent Violet VT2645 (Paul Uhlrich), Heliogen Green L8730 (BASF), Argyle Green XP-111-S (Paul Uhirich), Lithol Scarlet D3700 (BASF), Toluidine Red (Aldrich), Scarlet for Thermoplast NSD Red (Aldrich), Lithol Scarlet 4440, NBD 3700 (BASF), Bon Red C (Dominion Color), Royal Brilliant Red RD-8192 (Paul Uhlrich), Oracet Pink RF (Ciba Geigy), Paliogen Red 3340 and 3871 K (BASF), Lithol Fast Scarlet L4300 (BASF), Heliogen Blue D6840, D7080, K7090, K6910 and L7020 (BASF), Sudan Blue OS (BASF), Neopen Blue FF4012 (BASF), PV Fast Blue B2G01 (American Hoechst), Irgalite Blue BCA (Ciba Geigy), Paliogen Blue 6470 (BASF), Sudan II, III and IV (Matheson, Coleman, Bell), Sudan Orange (Aldrich), Sudan Orange 220 (BASF), Paliogen Orange 3040 (BASF), Ortho Orange OR 2673 (Paul Uhlrich), Paliogen Yellow 152 and 1560 (BASF), Lithol Fast Yellow 0991K (BASF), Paliotol Yellow 1840 (BASF), Novaperm Yellow FGL (Hoechst), Permanerit Yellow YE 0305 (Paul Uhlrich), Lumogen Yellow D0790 (BASF), Suco-Gelb 1250 (BASF), Suco-Yellow D1355 (BASF), Suco Fast Yellow D1165, D1355 and D1351 (BASF), Hostaperm Pink E (Hoechst), Fanal Pink D4830 (BASF), Cinquasia Magenta (DuPont), Paliogen Black L9984 9BASF), Pigment Black K801 (BASF) and particularly carbon blacks such as REGAL 330 (Cabot), Carbon Black 5250 and 5750 (Columbian Chemicals), and the like or mixtures thereof

Additional useful colorants include pigments in water based dispersions such as those commercially available from Sun Chemical, for example SUNSPERSE BHD 6011X (Blue 15 Type), SUNSPERSE BHD 9312X (Pigment Blue 15 74160), SUNSPERSE BHD 6000X (Pigment Blue 15:3 74160), SUNSPERSE GHiD 9600X and GHD 6004X (Pigment Green 7 74260), SUNSPERSE QHD 6040X (Pigment Red 122 73915), SUNSPERSE RHD 9668X (Pigment Red 185 12516), SUNSPERSE RED 9365X and 9504X (Pigment Red 57 15850;1, SUNSPERSE YHD 6005X (Pigment Yellow 83 21108), FLEXIVERSE YFD 4249 (Pigment Yellow 17 21105), SUNSPERSE YHD 6020X and 6045X (Pigment Yellow 74 11741), SUNSPERSE YHD 600X and 9604X (Pigment Yellow 14 21095), FLEXIVERSE LFD 4343 and LFD 9736 (Pigment Black 7 77226) and the like or mixtures thereof Other useful water based colorant dispersions include those commercially available from Clariant, for example, HOSTAFINE Yellow GR, HOSTAFINE Black T and Black TS, HOSTAFINE Blue B2G, HOSTAFINE Rubine F6B and magenta dry pigment.

Other useful colorants include, for example, magnetites, such as Mobay magnetites M08029, M08960; Columbian magnetites, MAPICO BLACKS and surface treated magnetites; Pfizer magnetites CB4799, CB5300, CB5600, MCX6369; Bayer magnetites, BAYFERROX 8600, 8610; Northern Pigments magnetites, NP-604, NP-608; Magnox magnetites TMB-100 or TMB-104; and the like or mixtures thereof. Specific additional examples of pigments include phthalocyanine HELIOGEN BLUE L6900, D6840, D7080, D7020, PYLAM OIL BLUE, PYLAM OIL YELLOW, PIGMENT BLUE 1 available from Paul Uhlrich & Company, Inc., PIGMENT VIOLET 1, PIGMENT RED 48, LEMON CHROME YELLOW DCC 1026, E.D. TOLUIDINE RED and BON RED C available from Dominion Color Corporation, Ltd., Toronto, Ontario, NOVAPERM YELLOW FGL, HOSTAPERM PINK E from Hoechst, and CINQUASIA MAGENTA available from E.L DuPont de Nemours & Company, and the like. Examples of magentas include, for example, 2,9-dimethyl substituted quinacridone and anthraquinone dye identified in the Color Index as CI 60710, CI Dispersed Red 15, diazo dye identified in the Color Index as CI 26050, CI Solvent Red 19, and the like or mixtures thereof. Illustrative examples of cyans include copper tetra(octadecyl sulfonamide) phthalocyanine, x-copper phthalocyanine pigment listed in the Color Index as C174160, Cl Pigment Blue, and Anthrathrene Blue identified in the Color Index as DI 69810, Special Blue X-2137, and the like or mixtures thereof. Illustrative examples of yellows that may be selected include diarylide yellow 3,3-dichlorobenzidene acetoacetanilides, a monoazo pigment identified in the Color Index as CI 12700, Cl Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,4-dimethoxy acetoacetanilide, and Permanent Yellow FGL. Colored magnetites, such as mixtures of MAPICOBLACK and cyan components may also be selected as pigments.

When the pigment is to be incorporated in a non-aqueous system for application to a substrate, it is generally necessary or desirable to remove the residual moisture from the press cake. The press cake typically contains 30 to 80% by weight water, but can contain any amount of water suitable to form the press cake. In an embodiment, the press cake contains 20 to 50% by weight of water.

As the pigment is wetted by the dispersant, the water is driven out of the press cake until only a small percentage of water remains in the pigment dispersion. The last traces of water can be removed by applying a sub-atmospheric pressure and/or heat to the pigment dispersion. Alternatively, this water can be removed from the mixture by decantation, centrifugation or other mechanical means.

Examples of suitable pigment dispersant materials include fatty amides, such as monoamides, triamides, tetra-amides, mixtures thereof, and the like. Further information on fatty amide carrier materials is disclosed in, for example, U.S. Pat. No. 4,889,560, U.S. Pat. No. 4,889,761, U.S. Pat. No. 5,194,638, U.S. Pat. No. 4,830,671, U.S. Pat. No. 6,174,937, U.S. Pat. No. 5,372,852, U.S. Pat. No. 5,597,856, U.S. Pat. No. 6,174,937, and British Patent GB 2 238 792, the disclosures of each of which are totally incorporated herein by reference. In one specific embodiment, the amide is a branched triamide. Branched triamides are disclosed in, for example, U.S. Pat. No. 6,860,930, the disclosure of which is totally incorporated herein by reference.

The flushing agent can be a resin, such as a triamide of the formula

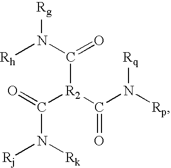

wherein R₂ is (i) an alkylene group having from about 3 carbon atoms to about 200 carbon atoms, (ii) an arylene group having from about 6 carbon atoms to about 200 carbon atoms, (iii) an arylalkylene group having from about 7 carbon atoms to about 200 carbon atoms, or (iv) an alkylarylene group having from about 7 carbon atoms to about 200 carbon atoms and R_{g}, Rₕ, Rⱼ, Rₖ, Rₚ and R_{q} are each independently (i) a hydrogen atom, (ii) an alkyl group having from about 1 carbon atoms to about 200 carbon atoms, (iii) an aryl group having from about 6 carbon atoms to about 200 carbon atoms, (iv) an arylalkyl group having from about 6 carbon atoms to about 200 carbon atoms, or (v) an alkylaryl group having from about 6 carbon atoms to about 200 carbon atoms.

The resin can also be, for example, a bis-urethane of the formula

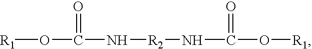

wherein each R₁ is independent of each other (i) an alkyl group having from about 1 carbon atoms to about 200 carbon atoms, (ii) an aryl group having from about 6 carbon atoms to about 200 carbon atoms, (iii) an arylalkyl group having from about 6 carbon atoms to about 200 carbon atoms, or (iv) an alkylaryl group having from about 6 carbon atoms to about 200 carbon atoms; and R₂ is (i) an alkylene group having from about 3 carbon atoms to about 200 carbon atoms, (ii) an arylene group having from about 6 carbon atoms to about 200 carbon atoms, (iii) an arylalkylene group having from about 7 carbon atoms to about 200 carbon atoms, or (iv) an alkylarylene group having from about 7 carbon atoms to about 200 carbon atoms.

Other resins include modified rosin esters, such as KE-100 resin, a glycerol ester of a hydrogenated rosin, which is available from Arakawa Chemical Industries Ltd. K-100 has demonstrated to be an excellent dispersing agent for some pigments.

Additional flushing agents and flushing aids can include unsaturated polyester and/or its derivatives, including polyester resins and branched polyester resins, polyimide resins, branched polyimide resins, poly(styrene-acrylate) resins, poly(styrene-methacrylate) resins, poly(styrene-butadiene) resins, alkali sulfonated-polyester resins, branched alkali sulfonated-polyester resins, alkali sulfonated-polyimide resins, branched alkali sulfonated-polyimide resins, alkali sulfonated poly(styrene-acrylate) resins, poly(styrene-methacrylate) resins, crosslinked alkali sulfonated-poly(styrene-methacrylate) resins, alkali sulfonated-poly(styrene-butadiene) resins, and crystalline polyester resins.

Illustrative examples of polymer resins selected for the process and particles of the present disclosure include any of the various polyesters, such as crystalline polyesters, amorphous polyesters, or a mixture thereo7f. Thus, for example, the particles can be comprised of crystalline polyester resins, amorphous polyester resins, or a mixture of two or more polyester resins where one or more polyester is crystalline and one or more polyester is amorphous.

Illustrative examples of crystalline polymer resins selected for the process and particles of the present disclosure include any of the various crystalline polyesters, such as poly(ethylene-adipate), poly(propylene-adipate), polytbutylene-adipate), poly(pentylene-adipate), poly(hexylene-adipate), poly(octylene-adipate), poly(ethylene-succinate), poly(propylene-succinate), polybutylene-succinate), poly(pentylene-succinate), poly(hexylene-succinate), poly(octylene-succinate), poly(ethylene-sebacate), poly(propylene-sebacate), polybutylene-sebacate), poly(pentylene-sebacate), polythexylene-sebacate), poly(octylene-sebacate), copoly(5-sulfoisophthaloyl)-copoly(ethylene-adipate), copoly(5-sulfoisophthaloyl)-copoly(propylene-adipate), copoly(5-sulfoisophthaloyl)-copoly(butylene-adipate), copoly(5-sulfo-isophthaloyl)-copoly(pentylene-adipate), copoly(5-sulfo-isophthaloyl)-copoly(hexylene-adipate), copoly(5-sulfo-isophthaloyl)-copoly(octylene-adipate), copoly(5-sulfo-isophthaloyl)-copoly(ethylene-adipate), copoly(5-sulfo-isophthaloyl)-copoly(propylene-adipate), copoly(5-sulfo-isophthaloyl)-copolyfbutylene-adipate), copoly(5-sulfo-isophthaloyl)-copolytpentylene-adipate), copoly(5-sulfo-isophthaloyl)-copoly(hexylene-adipate), copoly(5-sulfo-isophthaloyl)-copoly(octylene-adipate), copoly(5-sulfoisophthaloyl)-copoly(ethylene-succinate), copoly(5-sulfoisophthaloyl)-copoly(propylene-succinate), copoly(5-sulfoisophthaloyl)-copolyfbutylene-succinate), copoly(5-sulfoisophthaloyl)-copoly(pentylene-succinate), copoly(5-sulfoisophthaloyl)-copoly(hexylene-succinate), copoly(5-sulfoisophthaloyl)-copoly(octylene-succinate), copoly(5-sulfo-isophthaloyl)-copoly(ethylene-sebacate), copoly(5-sulfo-isophthaloyl)-copoly(propylene-sebacate), copoly(5-sulfo-isophthaloyl)-copoly(butylenes-sebacate), copoly(5-sulfo-isophthaloyl)-copoly(pentylene-sebacate), copoly(5-sulfo-isophthaloyl)-copoly(hexylene-sebacate), copoly(5-sulfo-isophthaloyl)-copoly(octylene-sebacate), copoly(5-sulfo-isophthaloyl)-copoly(ethylene-adipate), copoly(5-sulfo-isophthaloyl)-copoly(propylene-adipate), copoly(5-sulfo-isophthaloyl)-copoly(butylene-adipate), copoly(5-sulfo-isophthaloyl)-copoly(pentylene-adipate), copoly(5-sulfo-isophthaloyl)-copoly(hexylene-adipate), poly(octylene-adipate) and unsaturated copolyesters such as copoly(ethylene-sebacate)-copoly(ethylene-fumarate), copoly(ethylene-dodecanoate)-copoly(ethylene-fumarate), copoly(nonylene-sebacate)-copoly(nonylene-fumarate), copoly(nonylene-dodecanoate)-copoly(nonylene-fumarate), copoly(decylene-sebacate)-copoly(decyylene-fumarate), or copoly(decylene-dodecanoate)-copoly(decylene-fumarate), copoly(butylene-fumarate)-copoly(hexylene-fumarate) and the like.

The crystalline resins, which are available from a number of sources, can possess various melting points of, for example, from about 30° C. to about 120° C., such as from about 50° C. to about 90° C. The crystalline resin may have, for example, a number average molecular weight (Mn), as measured by gel permeation chromatography (GPC) of, for example, from about 1,000 to about 50,000, and preferably from about 2,000 to about 25,000. The weight average molecular weight (Mw) of the resin may be, for example, from about 2,000 to about 100,000, and preferably from about 3,000 to about 80,000, as determined by GPC using polystyrene standards. The molecular weight distribution (Mw/Mn) of the crystalline resin is, for example, from about 2 to about 6, and more specifically, from about 2 to about 4.

The crystalline resins can be prepared by a polycondensation process by reacting suitable organic diol(s) and suitable organic diacid(s) in the presence of a polycondensation catalyst. Generally, a stoichiometric equimolar ratio of organic diol and organic diacid is utilized, however, in some instances, wherein the boiling point of the organic diol is from about 180° C. to about 230° C., an excess amount of diol can be utilized and removed during the polycondensation process. The amount of catalyst utilized varies, and can be selected in an amount, for example, of from about 0.01 to about 1 mole percent of the resin. Additionally, in place of the organic diacid, an organic diester can also be selected, and where an alcohol byproduct is generated.

In a second embodiment, a pigment dispersion that is already prepared in a non-aqueous medium from the manufacturer can be used. Thus, the first process of flushing from an aqueous phase to a non-aqueous phase is not required, because in this embodiment the non-aqueous pigment dispersion is obtained directly from the manufacturer. In this embodiment, there is only the application of high shear mixing to the mixture. The resultant heat that is generated during the high shear mixing removes at least a portion of the non-aqueous solvent. Optionally, a vacuum can be applied to remove a substantial portion of any remaining solvent. The solvent in the pigment dispersion can have a boiling point that is lower than about 150° C. to hasten the vaporization or evaporation of the solvent during the high shear mixing and during the optional application of a vacuum.

Alternatively, the solvent from the original pigment dispersion can remain in the SIJ ink. For example, where a solvent has a high boiling point, for example, greater than about 150° C., or where it is not feasible to remove the solvent or other component, or where it is desirable to have an SIJ ink with some remaining solvent or other component, then the solvent or other component from the original pigment flush can be incorporated into the SIJ ink. For example, in the case of a resin-based pigment dispersion, such as made from a polyethylene-based flush, the polyethylene is not removed and becomes part of the SIJ ink.

In embodiments, other ingredients are added to the pigment dispersion to produce the SIJ ink. The volatile content of the non-aqueous medium used can be removed with heating the resulting ink at below about 150° C.

In embodiments, other ingredients may be added to the pigment dispersion. Such other ingredients may optionally include a wax, which can be either a single type of wax or a mixture of two or more different waxes. A single wax can be added to formulations, for example, to improve particular properties, such as hardness, gloss, offset properties, and the like. Alternatively, a combination of waxes can be added to provide multiple properties to the composition.

Suitable examples of waxes include waxes selected from natural vegetable waxes, natural animal waxes, mineral waxes, synthetic waxes and functionalized waxes. Examples of natural vegetable waxes include, for example, carnauba wax, candelilla wax, Japan wax, and bayberry wax. Examples of natural animal waxes include, for example, beeswax, punic wax, lanolin, lac wax, shellac wax, and spermaceti wax. Mineral waxes include, for example, paraffin wax, microcrystalline wax, montan wax, ozokerite wax, ceresin wax, petrolatum wax, and petroleum wax. Synthetic waxes include, for example, Fischer-Tropsch wax, acrylate wax, fatty acid amide wax, silicone wax, polytetrafluoroethylene wax, polymethylene wax, polyethylene wax, and polypropylene wax, and mixtures thereof.

Examples of waxes of embodiments include polypropylenes and polyethylenes commercially available from Allied Chemical and Baker Petrolite, polymethylenes from The International Group, Inc., wax emulsions available from Michelman Inc. and the Daniels Products Company, EPOLENE N-15 commercially available from Eastman Chemical Products, Inc., VISCOL 550-P, a low weight average molecular weight polypropylene available from Sanyo Kasei K.I., and similar materials. Suitable commercially available polymethylenes and polyethylenes usually possess a molecular weight Mw of from about 1,000 to about 1,500, while suitable commercially available polypropylenes have a molecular weight of about 4,000 to about 5,000. Examples of functionalized waxes include amines, amides, imides, esters, quaternary amines, carboxylic acids or acrylic polymer emulsion, for example, JONCRYL 74, 89, 130, 537, and 538, all available from Jolnson Diversey, Inc., chlorinated polypropylenes and chlorinated polyethylenes commercially available from Allied Chemical and Petrolite Corporation and Johnson Diversey, Inc. Many of the polyethylene and polypropylene compositions useful in embodiments are illustrated in British Pat. No. 1,442,835, the entire disclosure of which is incorporated herein by reference.

Optional additives may also be introduced to the pigment dispersion in preparing the SIJ ink in any embodiment. Optional additives include, but are not limited to, surfactants, light stabilizers, UV absorbers, which absorb incident UV radiation and convert it to heat energy that is ultimately dissipated, antioxidants, optical brighteners, which can improve the appearance of the image and mask yellowing, thixotropic agents, dewetting agents, slip agents, foaming agents, antifoaming agents, flow agents, other non-curable waxes, oils, plasticizers, binders, electrical conductive agents, fungicides, bactericides, organic and/or inorganic filler particles, leveling agents, e.g., agents that create or reduce different gloss levels, opacifiers, antistatic agents, dispersants, and the like. In particular, the composition may include, as a stabilizer, a radical scavenger, such as Irgastab UV 10 (Ciba Specialty Chemicals, Inc.).

Additionally, any suitable ink ingredient can be added in the SIJ ink. Examples of suitable ingredients can include paraffins, microcrystalline waxes, polyethylene waxes, ester waxes, fatty acids and other waxy materials, fatty amide containing materials, sulfonamide materials, resinous materials made from different natural sources (tall oil rosins and rosin esters, for example), and many synthetic resins, oligomers, polymers, and copolymers such as further discussed below, and mixtures thereof.

Examples of suitable ink ingredients include, for example, ethylene/propylene copolymers. The copolymers may have, for example, a melting point of from about 70° C. to about 150° C., such as from about 80° C. to about 130° C. or from about 90° C. to about 120° C. and a molecular weight range of from about 500 to about 4,000. Commercial examples of such copolymers include, for example, Petrolite CP-7 (Mn=650), Petrolite CP-11 (Mn=1,100, Petrolite CP-12 (Mn=1,200) and the like.

Urethane, urea, amide and imide derivatives of oxidized synthetic or petroleum waxes. In embodiments, the urethane, urea, amide and imide derivatives may be linear, branched, cyclic or any combination thereof. These materials may have a melting point of from about 60° C. to about 120° C., such as from about 70° C. to about 100° C. or from about 70° C. to about 90° C. Commercial examples of such materials include, for example, bis-urethanes such as PETROLITE CA-11®, PETROLITE WB-5® and PETROLITE WB-17®, all available from Baker Petrolite, and the like. Suitable examples also include urethane, urea, amide and imide derivatives disclosed in U.S. Pat. Nos. 6,620,228, 6,380,423, 6,464,766 and 6,309,453, each of which is incorporated herein by reference.

Other suitable carrier materials that can be used in SIJ ink compositions include, for example, isocyanate-derived resins and waxes, such as urethane isocyanate-derived materials, urea isocyanate-derived materials, urethane/urea isocyanate-derived materials, mixtures thereof, and the like. Further information on isocyanate-derived carrier materials is disclosed in, for example, U.S. Pat. Nos. 5,750,604, 5,780,528, 5,782,966, 5,783,658, 5,827,918, 5,830,942, 5,919,839, 6,255,432, and 6,309,453, British Patents Nos. GB 2 294 939, GB 2 305 928, GB 2 305 670, and GB 2 290 793, and PCT Publications WO 94/14902, WO 97/12003, WO 97/13816, WO 96/14364, WO 97/33943, and WO 95/04760, the entire disclosures of each of which are incorporated herein by reference.

Another type of ink vehicle may be n-paraffinic, branched paraffinic, and/or aromatic hydrocarbons, typically with from about 5 to about 100, such as from about 20 to about 180 or from about 30 to about 60 carbon atoms, generally prepared by the refinement of naturally occurring hydrocarbons, such as BE SQUARE 185 and BE SQUARE 195, with molecular weights (Mn) of from about 100 to about 5,000, such as from about 250 to about 1,000 or from about 500 to about 800, for example such as available from Petrolite.

Highly branched hydrocarbons, typically prepared by olefin polymerization, such as the VYBAR materials available from Petrolite, including VYBAR 253 (Mn=520), VYBAR 5013 (Mn=420), and the like, may also be used. In addition, the ink vehicle may be an ethoxylated alcohol, such as available from Petrolite and of the general formula

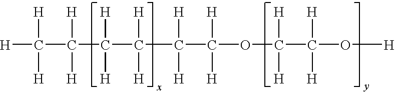

wherein x is an integer of from about 1 to about 50, such as from about 5 to about 40 or from about 11 to about 24 and y is an integer of from about 1 to about 70, such as from about 1 to about 50 or from about 1 to about 40. The materials may have a melting point of from about 60° C. to about 150° C., such as from about 70° C. to about 120° C. or from about 80° C. to about 110° C. and a molecular weight (Mn) range of from about 100 to about 5,000, such as from about 500 to about 3,000 or from about 500 to about 2,500. Commercial examples include UNITHOX 420 (Mn=560), UNITHOX 450 (Mn=900), UNITHOX 480 (Mn=2,250), UNITHOX 520 (Mn=700), UNITHOX 550 (Mn=1,100), UNITHOX 720 (Mn=875), UNITHOX 750 (Mn=1,400), and the like.

As an additional example, mention may be made of fatty amides, such as monoamides, tetra-amides, mixtures thereof, and the like, for example such as described in U.S. Pat. No. 6,858,070, incorporated herein by reference. Suitable monoamides may have a melting point of at least about 50° C., for example from about 50° C. to about 150° C., although the melting point can be below this temperature. Specific examples of suitable monoamides include, for example, primary monoamides and secondary monoamides. Stearamide, such as KEMAMIDE S available from Chemtura Corporation and CRODAMIDE S available from Croda, behenamide/arachidamide, such as CRODAMIDE BR available from Croda, oleamide, such as KEMAMIDE U available from Chemtura Corporation and CRODAMIDE OR available from Croda, technical grade oleamide, such as KEMAMIDE OR available from Chemtura Corporation, CRODAMIDE O available from Croda, and UNISLIP 1753 available from Uniqema, and erucamide such as KEMAMIDE E Ultra available from Chemtura Corporation, derived from a vegetable source, and CRODAMIDE ER available from Croda, are some examples of suitable primary amides. Stearyl stearamide, such as KEMAMIDE S-180 available from Chemtura Corporation, stearyl erucamide, such as KEMAMIDE E-180 available from Chemtura Corporation and CRODAMIDE 212 available from Croda, oleyl palmitamide, such as KEMAMIDE P-181 available from Chemtura Corporation and CRODAMIDE 203 available from Croda, and erucyl stearamide, such as KEMAMIDE S-221 available from Chemtura Corporation, are some examples of suitable secondary amides. Additional suitable amide materials include, Crodamide VRX, a refined vegetable oleamide available from Croda, Crodamide SRV, a refined vegetable stearamide available from Croda and derived entirely from GM-free vegetable feedstock, Crodamide EBO, an ethylene bis-oleamide available from Croda and KEMAMIDE W20 (N,N′-ethylenebisoleamide) Preferred Crodamide products are those derived from vegetable based materials (High Erucic Rapeseed Oil) such as: Crodamide E, Crodamide ER, Crodamide VRX, Crodamide SRV, Crodamide BR, Crodamide 203, Crodamide 212, Crodamide EBO, and optionally Crodamide EBSV, an ethylene bis-stearamide,

High molecular weight linear alcohols, such as those available from Petrolite and of the general formula

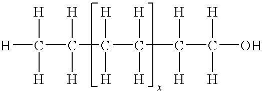

wherein x is an integer of from about 1 to about 50, such as from about 5 to about 35 or from about 11 to about 23, may also be used as the ink vehicle. These materials may have a melting point of from about 50° C. to about 150° C., such as from about 70° C. to about 120° C. or from about 75° C. to about 110° C., and a molecular weight (Mn) range of from about 100 to about 5,000, such as from about 200 to about 2,500 or from about 300 to about 1,500, Commercial examples include the UNILIN materials such as UNILIN 425 (Mn=460), UNILIN 550 (Mn=550), UNILIN 700 (Mn=700), and the like.

A still further example includes hydrocarbon-based waxes, such as the homopolymers of polyethylene available from Petrolite and of the general formula

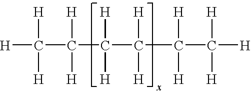

wherein x is an integer of from about 1 to about 200, such as from about 5 to about 150 or from about 12 to about 105. These materials may have a melting point of from about 60° C. to about 150° C., such as from about 70° C. to about 140° C. or from about 80° C. to about 130° C. and a molecular weight (Mn) of from about 100 to about 5,000, such as from about 200 to about 4,000 or from about 400 to about 3,000. Example waxes include the line of waxes, such as POLYWAX 500 (Mn=500), POLYWAX 655 (Mn=655), POLYWAX 850 (Mn=850), POLYWAX 1000 (Mn=1,000), and the like.

Another example includes modified maleic anhydride hydrocarbon adducts of polyolefins prepared by graft copolymerization, such as those available from Petrolite and of the general formulas

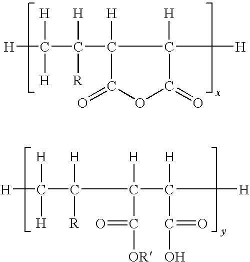

wherein R is an alkyl group with from about 1 to about 50, such as from about 5 to about 35 or from about 6 to about 28 carbon atoms, 11 is an ethyl group, a propyl group, an isopropyl group, a butyl group, an isobutyl group, or an alkyl group with from about 5 to about 500, such as from about 10 to about 300 or from about 20 to about 200 carbon atoms, x is an integer of from about 9 to about 13, and y is an integer of from about 1 to about 50, such as from about 5 to about 25 or from about 9 to about 13, and having melting points of from about 50° C. to about 150° C. such as from about 60° C. to about 120° C. or from about 70° C. to about 1 00° C.; those available from Petrolite and of the general formula

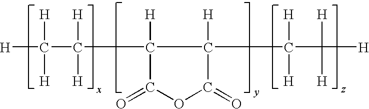

wherein x is an integer of from about 1 to about 50, such as from about 5 to about 25 or from about 9 to about 13, y is 1 or 2, and z is an integer of from about 1 to about 50, such as from about 5 to about 25 or from about 9 to about 13; and those available from Petrolite and of the general formula

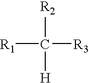

wherein R₁ and R₃ are hydrocarbon groups and R₂ is either of one of the general formulas

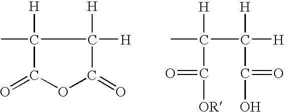

or a mixture thereof wherein R′ is an isopropyl group, which materials may have melting points of from about 70° C. to about 150° C., such as from about 80° C. to about 130° C. or from about 90° C. to about 125° C., with examples of modified maleic anhydride copolymers including CERAMER 67 (Mn=655, Mw/Mn=1.1), CERAMER 1608 (Mn =700, Mw/Mn=1.7), and the like.

Additional examples of suitable ink vehicles for the SIJ inks include polyamides; dimer acid amides; fatty acid amides, including ARAMID C; epoxy resins, such as EPOTUF 37001, available from Riechold Chemical Company; fluid paraffin waxes; fluid microcrystalline waxes; Fischer-Tropsch waxes; polyvinyl alcohol resins; polyols; cellulose esters; cellulose ethers; polyvinyl pyridine resins; fatty acids; fatty acid esters; poly sulfonamides, including KETJENFLEX MH and KETJENFLEX MS80; benzoate esters, such as BENZOFLEX S552, available from Velsicol Chemical Company; phthalate plasticizers; citrate plasticizers; maleate plasticizers; polyvinyl pyrrolidinone copolymers; polyvinyl pyrrolidone/polyvinyl acetate copolymers; novolac resins, such as DUREZ 12 686, available from Occidental Chemical Company; and natural product waxes, such as beeswax, montan wax, candelilla wax, GILSONITE (American Gilsonite Company), and the like; mixtures of linear primary alcohols with linear long chain amides or fatty acid amides, such as those with from about 6 to about 24 carbon atoms, including PARICIN 9 (propylene glycol monohydroxystearate), PARICIN 13 (glycerol monohydroxystearate), PARICIN 15 (ethylene glycol monohydroxystearate), PARICIN 220 (N(2-hydroxyethyl)-12-hydroxystearamide), PARICIN 285 (N,N′-ethylene-bis-12-hydroxystearamide), FLEXRICIN 185 (N,N′-ethylene-bis-ricinoleamide), and the like. Further, linear long chain sulfones with from about 4 to about 16 carbon atoms, such as diphenyl sulfone, n-amyl sulfone, n-propyl sulfone, n-pentyl sulfone, n-hexyl sulfone, n-heptyl sulfone, n-octyl sulfone, n-nonyl sulfone, n-decyl sulfone, n-undecyl sulfone, n-dodecyl sulfone, n-tridecyl sulfone, n-tetradecyl sulfone, n-pentadecyl sulfone, n-hexadecyl sulfone, chlorophenyl methyl sulfone, and the like, are suitable ink vehicle materials.

In addition, the ink vehicles described in U.S. Pat. No. 6,906,118, which is incorporated herein by reference in its entirety, may also be used. Also suitable as ink ingredients are liquid crystalline materials as disclosed in, for example, U.S. Pat. No. 5,122,187, the disclosure of which is totally incorporated herein by reference.

The ink vehicle may comprise one or more of the aforementioned suitable materials.

The ink vehicle may comprise from about 60% to about 99.5% by weight of the ink, for example from about 70% to about 98% or from about 80% to about 95% by weight of the ink.

Many ink vehicles of SIJ inks have an electrical conductivity of essentially zero. Thus, conductivity enhancing agents may be added to the ink in order to provide consistent conductivity to the ink. The conductivity is used as an input signal for a level sensor in the ink reservoir of the inkjet device.

Prior components of an SIJ ink that may have contributed to the electrical conductivity if the inks were colorants such as pigments and dyes, and dodecyl benzene sulfonic acid (DDBSA), as disclosed in U.S. Pat. No. 6,015,847, and incorporated herein by reference.

In embodiments, the conductivity enhancing agent is an organic salt formed from an organic base and an acid. The conductivity enhancing agent does not detrimentally affect any printer parts (for example, printheads or reservoirs of an inkjet device) as do other conductivity enhancing agents (for example, DDBSA).

The organic base of the organic salt of the conductivity enhancing agent may be an organic amine and have at least one long hydrocarbon chain. “Long hydrocarbon chain” refers to, for example, a linear or branched carbon alkyl or aryl chain having from about 10 carbons to about 50 carbons, such as from about 15 to about 40 carbons or from about 15 carbons to about 30 carbons. The long carbon chain of the organic salt allows it to be miscible in the ink.

Examples of organic bases that are suitable ingredients are derived from tertiary amine compounds having the following generic formula, which may include tri-hexadecyl amine (ARMEEN® 316, molecular weight 689).

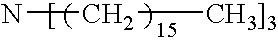

In embodiments the organic bases may be derived from trioctadecyl amine, tridodecyl amine, tritetradecyl amine, tnreicosyl amine, tridocosylamine, tritetracosylamine, mixed forms like didodecyl octadecyl amine, didocosyl tetracosyl amine, ditetracosyl tetradecyl amine, and the like, and aryl-aliphatic compounds, such as di(1-decyl-4-nonyl-phenyl) docosyl amine:

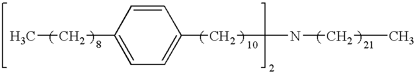

or 4-nonylphenyl dioctadecyl amine, as shown below:

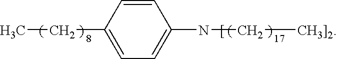

In embodiments, the organic base may be a primary, secondary or tertiary amine. An example of a suitable primary amine may be represented by the general formula

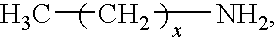

wherein x is an integer from about 1 to about 50, such as from about 10 to about 40 or from about 12 to about 30, for example, a hexadecyl amine. An example of a suitable secondary amine may be represented by the general formula

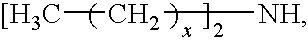

wherein x is an integer from about 1 to about 50, such as from about 10 to about 40 or from about 12 to about 30, for example, a di-octadecyl amine.

Another aspect is that the molecular ion of an acid suitable for use herein has a high mobility, thus enhancing the conductivity of the SIJ ink. This high mobility may be achieved by using a small molecular ion. However, when small molecular ions are used, the solubility of the organic salt decreases. Thus, the size of the molecular ion must be sufficient to maintain the solubility of the organic salt in the SIJ ink, while at the same time exhibiting sufficient mobility so as to enhance the conductivity of the SIJ ink.

Examples of acid generated suitable molecular ions that may be used herein include the ions of acids such as trifluoroacetic acid, methane sulfonic acid and trifluoro methane sulfonic acid. Such acids may have a molecular weight from about 25 to about 250, such as from about 25 to about 225 or from about 50 to about 250.

The estimated half-life of the organic salt under a constant temperature of about 120° C. is from about 15 days to about 250 days, such as from about 20 days to about 225 days or from about 20 days to about 200 days.

The SIJ ink disclosed herein may contain as an ingredient one organic salt, or a mixture of one or more suitable organic salts, for example from about 1 to about 10 organic salts, such as from about 1 to about 4 or from about 1 to about 2 organic salts. Each organic salt is present in the ink in any effective amount, for example from about 0.001 weight percent to about 8 weight percent, such as from about 0.1 weight percent to about 5 weight percent or from about 0.25 weight percent to about 5 weight percent of the ink.

The organic salt described herein imparts a high electrical conductivity to SIJ inks by sufficiently dissociating into molecular ions with high ion mobility. Specifically, the organic salt will dissociate into ions, that is, anions and cations, to provide the SIJ ink with high electrical conductivity during operation of an inkjet device.

The conductivity of the SIJ ink having the conductivity enhancing agent therein may be from about 0.01 μS/cm to about 5 μS/cm, such as from about 0.05 μS/cm to about 4 μS/cm or from about 0.09 μS/cm to about 2.5 μS/cm. Conductivity may be measured by any known method, and herein is measured under melt conditions at about 120° C. by placing titanium electrodes in the molten ink and reading the resistivity output on a Rosemount Model 1054B LC Conductivity Meter at a frequency of 60 Hz. In general, the conductivity of a material can be measured in terms of the reciprocal of resistivity, which is a material specific and temperature dependent measurement for electrical resistance.

The organic salts disclosed herein are soluble in the nonpolar organic environment of SIJ inks, demonstrate thermal stability in SIJ inks when an inkjet device is operating, are waxy solids at room temperature, may positively influence the mechanical durability of printed, solid inks, and do not etch or attack printer parts which may contact the organic salts found in the SIJ inks.

Other optional additives such as dispersing agents or surfactants may be present in the inks, typically in amounts of from about 0.01 to about 20 percent by weight. Plasticizers that may be used include pentaerythritol tetrabenzoate, commercially available as BENZOFLEX S552 (Velsicol Chemical Corporation), trimethyl titrate, commercially available as CITROFLEX 1 (Monflex Chemical Company), N,N-dimethyl oleamide, commercially available as HALCOMID M-18-OL (C. P. Hall Company), a benzyl phthalate, commercially available as SANTICIZER 278 (Ferro Corporation), and the like, may be added to the ink vehicle, and may constitute from about 1 to 40 percent of the ink vehicle component of the ink. Plasticizers can either function as the ink vehicle or can act as an agent to provide compatibility between the ink components.

Optional antioxidants in the ink may protect the images from oxidation and also may protect the ink components from oxidation while existing as a heated melt in the ink reservoir. Examples of suitable antioxidants include (1) N,N′-hexamethylene bis(3,5-di-tert-butyl-4-hydroxy hydrocinnamamide) (IRGANOX 1098, available from Ciba-Geigy Corporation), (2) 2,2-bis(4-(2-(3,5-di-tert-butyl-4-hydroxyhydrocinnamoyloxy))ethoxyphenyl) propane (TOPANOL-205, available from ICI America Corporation), (3) tris(4-tert-butyl-3-hydroxy-2,6-dimethyl benzyl) isoCyanurate (CYANOX 1790, 41,322-4, LTDP, Aldrich D12,840-6), (4) 2,2′-ethylidene bis(4,6-di-tert-butylphenyl) fluoro phosphonite (ETHANOX-398, available from Ethyl Corporation), (5) tetTakis(2,4-di-tert-butylphenyl)-4,4′-biphenyl diphosphonite (ALDRICH 46,852-5; hardness value 90), (6) pentaerythritol tetrastearate (TCI America #PO739), (7) tributylammonium hypophosphite (Aldrich 42,009-3), (8) 2,6-di-tert-butyl-4-methoxyphenol (Aldrich 25,106-2), (9) 2,4-di-tert-butyl-6-(4-methoxybenzyl) phenol (Aldrich 23,008-1), (10) 4-bromo-2,6-dimethylphenol (Aldrich 34,951-8), (11) 4-bromo-3,5-didimetlhylphenol (Aldrich B6,420-2), (12) 4-bromo-2-nitrophenol (Aldrich 30,987-7), (13) 4-(diethyl aminomethyl)-2,5-dimethylphenol (Aldrich 14,668-4), (14) 3-dimethylaminophenol (Aldrich DI14,400-2), (15) 2-amino-4-tert-amylphenol (Aldrich 41,258-9), (16) 2,6-bis(hydroxymethyl)-p-cresol (Aldrich 22,752-8), (17) 2,2′-methylenediphenol (Aldrich B4,680-8), (18) 5-(diethylamino)-2-nitrosophenol (Aldrich 26,951-4), (19) 2,6-dichloro-4-fluorophenol (Aldrich 28,435-1), (20) 2,6-dibromo fluoro phenol (Aldrich 26,003-7), (2 1) a-trifluoro-o-creso- I (Aldrich 21,979-7), (22) 2-bromo-4-fluorophenol (Aldrich 30,246-5), (23) 4-fluorophenol (Aldrich F1,320-7), (24) 4-chlorophenyl-2-chloro- 1,1,2-tri-fluoroethyl sulfone (Aldrich 13,823-1), (25) 3,4-difluoro phenylacetic acid (Aldrich 29,043-2), (26) 3-fluorophenylacetic acid (Aldrich 24,804-5), (27) 3,5-difluoro phenylacetic acid (Aldrich 29,044-0), (28) 2-fluorophenylacetic acid (Aldrich 20,894-9), (29) 2,5-bis (trifluoromethyl) benzoic acid (Aldrich 32,527-9), (30) ethyl-2-(4-(4-(trifluoromethyl) phenoxy) phenoxy) propionate (Aldrich 25,074-0), (31) tetrakis (2,4-di-tert-butyl phenyl)-4,4′-biphenyl diphosphonite (Aldrich 46,852-5), (32) 4-tert-amyl phenol (Aldrich 15,384-2), (33) 3-(2H-benzotriazol-2-yl)-4-hydroxy phenethylalcohol (Aldrich 43,071-4), NAUGARD 76, NAUGARD 445, NAUGARD 512, AND NAUGARD 524 (manufactured by Uniroyal Chemical Company), and the like, as well as mixtures thereof. The antioxidant, when present, may be present in the ink in any desired or effective amount, such as from about 0.15 percent to about 10 percent by weight of the ink or from about 0.2 percent to about 3 percent by weight of the ink.

The ink can also optionally contain a UV absorber. The optional UV absorbers primarily protect the generated images from UV degradation. Specific examples of suitable UV absorbers include (1) 2-bromo-2′,4-dimethoxyacetophenone (Aldrich 19,948-6), (2) 2-bromo-2′,5′-dimethoxyacetophenone (Aldrich 10,458-2), (3) 2-bromo-3′-nitroacetophenone (Aldrich 34,421-4), (4) 2-bromo-4′-nitroacetophenone (Aldrich 24,561-5), (5) 3′,5′-diacetoxyacetophenone (Aldrich 11,738-2), (6) 2-phenylsulfonyl acetophenone (Aldrich 34,150-3), (7) 3′-aminoacetophenone (Aldrich 13,935-1), (8) 4′-aminoacetophenone (Aldrich A3,800-2), (9) 1H-benzotriazole-1-acetonitrile (Aldrich 46,752-9), (10) 2-(2H-benzotriazol-2-yl)-4,6-di-tert-pentylphenol (Aldrich 42,274-6), (11) 1,1-(1,2-ethane-diyl)bis(3′,3,5,5-tetrametlhylpiperazinone) (commercially available from Goodrich Chemicals), (12) 2,2,4-trimethyl-1,2-hydroquinoline (commercially available from Mobay Chemical), (13) 2-(4-benzoyl-3-hydroxy phenoxy)ethylacrylate, (14) 2-dodecyl-N-(1,2,2,6,6-pentamethyl-4-piperidinyl) succinimide (commercially available from Aldrich Chemical Co., Milwaukee, Wis.), (15) 2,2,6,6-tetramethyl-4-piperidinyl/p-tetramethyl-3,9-(2,4, 8,10-tetraoxo spiro(5,5)-undecane) diethyl-1,2,3,4-butane tetracarboxylate (commercially available from Fairmount), (16) N-(p-ethoxycarbonylphenyl)-N′-ethyl-N′-phenylformadine (commercially available from Givaudan), (17) 6-ethoxy-1,2-dihydro-2,2,4-trimethylquinoline (commercially available from Monsanto Chemicals), (18) 2,4,6-tris-(N-1,4-dimethylpentyl-4-phenylenediamino)-1,3,5-triazine (commercially available from Uniroyal), (19) 2-dodecyl-N-(2,2,6,6-tetrame-thyl-4-piperidinyl) succinimide (commercially available from Aldrich Chemical Co.), (20) N-(1-acetyl-2,2,6,6-tetramethyl-4-piperidinyl)-2-dodecyl succinimide (commercially available from Aldrich Chemical Co.), (21) (1,2,2,6,6-pentamethyl-4-piperidinyl/p-tetramethyl-3,9-(2,4,8,10-tetra oxo-spiro-(5,5)undecane)diethyl)-1,2,3,4-butane tetracarboxylate (commercially available from Fairmount), (22) (2,2,6,6-tetramethyl-4-piperidinyl)-1,2,3,4-butane tetracarboxylate (commercially available from Fairmount), (23) nickel dibutyl dithio carbamate (commercially available as UV-Chek AM-105 from Ferro), (24) 2-amino-2′,5-dichlorobenzophenone (Aldrich 10,515-5), (25) 2′-amino-4′,5′-dimethoxyacetophenone (Aldrich 32,922-3), (26) 2-benzyl-2-(dimethylamino)-4′-morpholino butyrophenone (Aldrich 40,564-7), (27) 4′-benzyloxy-2′-hydroxy-3′-methylacetophenone (Aldrich 29,884-0), (28) 4,4′-bis(diethylamino) benzophenone (Aldrich 16,032-6), (29) 5-chloro-2-hydroxy benzophenone (Aldrich C4,470-2), (30) 4′-piperazinoacetophenone (Aldrich 13,646-8), (31) 4′-piperidinoacetophenone (Aldrich 11,972-5), (32) 2-amino-5-chlorobenzophenone (Aldrich A4,556-4), (33) 3,6-bis(2-methyl-2-morpholinopropionyl)-9-octylcarbazole (Aldrich 46,073-7), and the like, as well as mixtures thereof. When present, the optional UV absorber may be present in the ink in any desired or effective amount, such as from about 1 percent to about 10 percent by weight of the ink or from about 3 percent to about 5 percent by weight of the ink.

The inks can be employed in apparatus for direct printing inkjet processes, wherein when droplets of the melted ink are ejected in an imagewise pattern onto a recording substrate, the recording substrate is a final recording substrate. Alternatively, the inks can be employed in indirect (offset) printing inkjet applications, wherein when droplets of the melted ink are ejected in an imagewise pattern onto a recording substrate, the recording substrate is an intermediate transfer member and the ink in the imagewise pattern is subsequently transferred from the intermediate transfer member to a final recording substrate.

The substrate may be any suitable material such as paper, boxboard, cardboard, fabric, a transparency, plastic, glass, wood etc., although the ink is desirably used in forming images on paper.

The present disclosure is also directed to a printer containing the inks described herein. Specifically, the present disclosure relates to a printer cartridge containing the inks described herein, as well as to a printer containing the printer cartridge.

The present disclosure also relates to a method for applying the ink to form an image. In embodiments, the method comprises providing the ink at or above the first temperature; applying the ink to a substrate to form an image, the substrate being at or below the second temperature. In a preferred embodiment, the composition is applied over the image by inkjet printing.

Examples are set forth below and are illustrative of different compositions and conditions that can be utilized in practicing the disclosure. All proportions are by weight unless otherwise indicated. It will be apparent, however, that the disclosure can be practiced with many types of compositions and can have many different uses in accordance with the disclosure above and as pointed out hereinafter.

### EXAMPLES

Preparation of Flush Pigments

Flush Pigment Dispersion A: A 1 kg pigment press cake of Hostaperm Pink E02, from Clariant Corporation, is mixed with 1.4 kg of triamide resin (the triamide is described in U.S. Pat. No. 6,860,930) and 200 g of, PETROLITE® WB-17 (a bis-urethane) obtained from Baker Petrolite, at 120° C. for less than about one hour in a Kady® mill by high shear mixing. As the mixing proceeds, the surface of the pigment in the pigment press cake becomes receptive to the triamide resin while the water and potentially other liquids, such as glycols, becomes displaced or flushed from the pigment surface. The water is then removed from the mixture by continued heating from extended shearing to allow its evaporation resulting in a flushed pigmented dispersion having about 20% pigment in the mixture with a trace amount of residual water.

Flush Pigment Dispersion B: A 1 kg pigment press cake of Hostaperm Pink E02 is mixed with 1.4 kg of KE-100 resin (a glyceryl acetate) obtained from Arakawa Chemical Industries Ltd. and 200 g of PETROLITE® WB-17 at 120° C. for less than about one hour in a Kady® mill. As the mixing proceeds, the surface of the pigment in the pigment press cake becomes receptive to the KE-100 resin while the water and potentially other liquids, such as glycols, becomes displaced or flushed from the pigment surface. The water is then removed from the mixture by continued heating from extended shearing to allow its evaporation resulting in a flushed pigmented dispersion having about 20% pigment in the mixture with a trace amount of residual water.

Flush Pigment Dispersion C: A 1 kg pigment press cake of Hostaperm Pink E02, is mixed with 1.4 kg of triamide resin and 200 g of OLOA® 11000 from Chevron Oronite Company, at 120° C. for less than about one hour in a Kady® mill. As the mixing proceeds, the surface of the pigment in the pigment press cake becomes receptive to the triamide resin while the water and potentially other liquids, such as glycols, becomes displaced or flushed from the pigment surface. The water is then removed from the mixture by continued heating from extended shearing to allow its evaporation resulting in a flushed pigmented dispersion having about 20% pigment in the mixture with a trace amount of residual water.

Flush Pigment Dispersion D: A 1 kg pigment press cake of PV Fast Blue BG, from Clariant Corporation, is mixed with 1.4 kg of triamide resin and 200 g of Bis-urethane, PETROLITE® WB- 17, obtained from Baker Petrolite, at 120° C. for less than about one hour in a Kady® mill. As the mixing proceeds, the surface of the pigment in the pigment press cake becomes receptive to the triamide resin while the water and potentially other liquids, such as glycols, becomes displaced or flushed from the pigment surface. The water is then removed from the mixture by continued heating from extended shearing to allow its evaporation resulting in a flushed pigmented dispersion having about 20% pigment in the mixture with a trace amount of residual water.

Flush Pigment Dispersion E: A 1 kg pigment press cake of Carbazole Violet, from Sun Chemical Corporation, is mixed with 1.4 kg of triamide resin and 200 g of Bis-urethane, PETROLITE® WB-17, obtained from Baker Petrolite, at 120° C. for less than about one hour in a Kady® mill. As the mixing proceeds, the surface of the pigment in the pigment press cake becomes receptive to the triamide resin while the water and potentially other liquids, such as glycols, becomes displaced or flushed from the pigment surface. The water is then removed from the mixture by continued heating from extended shearing to allow its evaporation resulting in a flushed pigmented dispersion having about 20% pigment in the mixture with a trace amount of residual water.

Flush Pigment Dispersion F: A 1 kg pigment press cake of Benzimidazolone Orange, from Sun Chemical Corporation, is mixed with 1.4 kg of triamide resin and 200 g of Bis-urethane, PETROLITE® WB-17, obtained from Baker Petrolite, at 120° C. for less than about one hour in a Kady® mill. As the mixing proceeds, the surface of the pigment in the pigment press cake becomes receptive to the triamide resin while the water and potentially other liquids, such as glycols, becomes displaced or flushed from the pigment surface. The water is then removed from the mixture by continued heating from extended shearing to allow its evaporation resulting in a flushed pigmented dispersion having about 20% pigment in the mixture with a trace amount of residual water.

Preparation of Inks

### Example 1

Flush Pigment Dispersion A is diluted with the remaining ink ingredients forming an ink. The following components were then melted and stir-mixed in a 4 liter beaker at 125° C.: Flush Pigment Dispersion A (243 grams); stearyl stearamide wax (KEMAMIDE® S-180, obtained from Crompton Corp., Greenwich, Conn., 463.55 g); KE-100 resin (a glycerol ester of a hydrogenated rosin, obtained from Arakawa Chemical Industries Ltd., 309.03 grams; NAUGARD® N445 antioxidant (obtained from Crompton Corp., Greenwich, Conn., 4.09 grams), X1197 polyethylene wax (from Baker Petrolite, 1236.13 g), and a urethane resin prepared as described in Example 4 of U.S. Pat. No. 6,309,453, the disclosure of which is totally incorporated herein by reference (55.20 grams).

The above ingredients (Flush Pigment Dispersion A, stearyl stearamide wax, KE-100 resin, NAUGARD® N445 antioxidant, X1197 polyethylene wax, and the urethane resin) are homogenized in an IKA® Ultra Turrax T50 Homogenizer for an additional 60 minutes at 120° C. to allow the ink to mix and to remove the trace amount of water remaining in the pigment dispersion. The resulting ink is then filtered through a 1 μm glass fiber cartridge-filter at about 115° C. and demonstrates good print quality performance in a Xerox solid inkjet printer.

The various compositions of a pigmented SIJ ink formulation are set forth in Table 1 below:

TABLE 1

| Ingredient | Weight Percentage |
|---|---|
| Pigment | 0.5-15% |
| Triamide resin | 5-20% |
| A glycerol ester of | 0-20% |
| a hydrogenated | |
| rosin | |
| Polyalkylene | 0-15% |
| succinimide | |
| Stearyl stearamide | 10-20% |
| Urethane | 0-5% |
| Polyethylene wax | 20-60% |
| bis-urethane | 0-5% |
| Antioxidant | 0.2% |

### Example 2

Flush Pigment Dispersion B is diluted with the remaining ink ingredients forming an ink. The following components were then melted and stir-mixed in a 4 liter beaker at 125° C.: Flush Pigment Dispersion B (243 grams); stearyl stearamide wax (K-EMAMIDE® S-180, 463.55 g); triamide resin (309.03 grams); NAUGARD® N445 antioxidant (4.09 grams), X1197 polyethylene wax (1236.13 g), and a urethane resin prepared as described in Example 4 of U.S. Pat. No. 6,309,453 (55.20 grams).

The above ingredients are homogenized in an IKA® Ultra Turrax T50 Homogenizer for an additional 60 minutes at 120° C. to allow the ink to mix and to remove the trace amount of water remaining in the pigment dispersion. The resulting ink is then filtered through a 1 μm glass fiber cartridge-filter at 115° C. and demonstrates good print quality performance in a Xerox solid inkjet printer.

### Example 3

Flush Pigment Dispersion C is diluted with the remaining ink ingredients forming an ink. The following components are then melted and stir-mixed in a 4 liter beaker at 125° C.: Flush Pigment Dispersion C (243 grams); stearyl stearamide wax (KEMAMIDE® S-180, 463.55 g); KE-100 resin (309.03 grams); NAUGARD® N445 antioxidant (4.09 grams), X1197 polyethylene wax (1236.13 g), and a urethane resin prepared as described in Example 4 of U.S. Pat. No. 6,309,453 (55.20 grams).

The above ingredients are homogenized in an IKA® Ultra Turrax T50 Homogenizer for an additional 60 minutes at 120° C. to allow the ink to mix and to remove the trace amount of water remaining in the pigment dispersion. The resulting ink is then filtered through a 1 μm glass fiber cartridge-filter at 115° C. and demonstrates good print quality performance in a Xerox solid inkjet printer.

### Example 4

Flush Pigment Dispersion D is diluted with the remaining ink ingredients forming an ink. The following components are then melted and stir-mixed in a 4 liter beaker at 125° C.: Flush Pigment Dispersion D (243 grams); stearyl stearamide wax (KEMAMIDE® S-180, 463.55 g); KE-100 resin (309.03 grams); NAUGARD® N445 antioxidant (4.09 grams), X1197 polyethylene wax (1236.13 g), and a urethane resin prepared as described in Example 4 of U.S. Pat. No. 6,309,453 (55.20 grams).

The above ingredients are homogenized in an IKA® Ultra Turrax T50 Homogenizer for an additional 60 minutes at 120° C. to allow the ink to mix and to remove the trace amount of water remaining in the pigment dispersion. The resulting ink is then filtered through a 1 μm glass fiber cartridge-filter at 115° C. and demonstrates good print quality performance in a Xerox solid inkjet printer.

### Example 5

Flush Pigment Dispersion E is diluted with the remaining ink ingredients forming an ink. The following components were then melted and stir-mixed in a 4 liter beaker at 125° C.: Flush Pigment Dispersion E (243 grams); stearyl stearamide wax (KEMAMIDE® S-180, 463.55 g); KE-100 resin (309.03 grams); NAUGARD® N445 antioxidant (4.09 grams), X1197 polyethylene wax (1236.13 g), and a urethane resin prepared as described in Example 4 of U.S. Pat. No. 6,309,453 (55.20 grams).

The above ingredients are homogenized in an IKA® Ultra Turrax T50 Homogenizer for an additional 60 minutes at 120° C. to allow the ink to mix and to remove the trace amount of water remaining in the pigment dispersion. The resulting ink is then filtered through a 1 μm glass fiber cartridge-filter at 115° C. and demonstrates good print quality performance in a Xerox solid inkjet printer.

### Example 6

Flush Pigment Dispersion F is diluted with the remaining ink ingredients forming an ink. The following components are then melted and stir-mixed in a 4 liter beaker at 125° C. Flush Pigment Dispersion F (243 grams); stearyl stearamide wax (KEMAMIDE® S-180, 463.55 g); KE-100 resin (309.03 grams); NAUGARD® N445 antioxidant (4.09 grams), X1197 polyethylene wax (1236.13 g), and a urethane resin prepared as described in Example 4 of U.S. Pat. No. 6,309,453 (55.20 grams).

The above ingredients are homogenized in an IKA® Ultra Turrax T50 Homogenizer for an additional 60 minutes at 120° C. to allow the ink to mix and to remove the trace amount of water remaining in the pigment dispersion. The resulting ink is then filtered through a 1 μm glass fiber cartridge-filter at 115° C. and demonstrates good print quality performance in a Xerox solid inkjet printer.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

1. A process for preparing a solid inkjet ink, comprising:
applying a first mixing step to a pigment that is part of an aqueous press cake and a flushing agent that is an ingredient of the solid inkjet ink to flush the pigment from an aqueous phase to a non-aqueous phase to form a first pigment dispersion;
adding one or more ink ingredients to the first pigment dispersion; and
applying a second mixing step to the first pigment dispersion and the one or more ink ingredients to incorporate the pigment dispersion with the one or more ink ingredients to form a second pigment dispersion; and
solidifying the second pigment dispersion to form a solid inkjet ink.

2. (canceled)

3. The process according to claim 1, wherein the press cake comprises about 15% to about 70% by weight of pigment.

4. The process according to claim 1, wherein the press cake comprises about 30% to about 50% by weight of pigment.

5. The process according to claim 1, wherein the flushing agent comprises at least one resin and one or more of a surfactant, a volatile polar vehicle, a dispersant, an oligomer or a polymer.

6. The process according to claim 1, wherein the ink ingredient is a wax, a colorant, a resin, or combinations thereof.

7. The process according to claim 1, wherein the flushing agent is a triamide resin of the formula 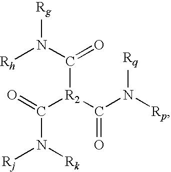
wherein R₂ is (i) an alkylene group having from about 3 carbon atoms to about 200 carbon atoms, (ii) an arylene group having from about 6 carbon atoms to about 200 carbon atoms, (iii) an arylalkylene group having from about 7 carbon atoms to about 200 carbon atoms, or (iv) an alkylarylene group having from about 7 carbon atoms to about 200 carbon atoms and R_{g}, Rₕ, Rⱼ, Rₖ, Rₚ and R_{q} are each independently (i) a hydrogen atom, (ii) an alkyl group having from about 1 carbon atoms to about 200 carbon atoms, (iii) an aryl group having from about 6 carbon atoms to about 200 carbon atoms, (iv) an arylalkyl group having from about 6 carbon atoms to about 200 carbon atoms, or (v) an alkylaryl group having from about 6 carbon atoms to about 200 carbon atoms.

8. The process according to claim 1, wherein the flushing agent is a glycerol ester of a hydrogenated rosin.

9. The process according to claim 1, wherein the flushing agent is a mixture of a glycerol ester of a hydrogenated rosin and a triamide resin of the formula 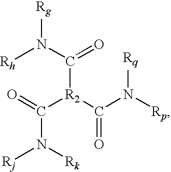
wherein R₂ is (i) an alkylene group having from about 3 carbon atoms to about 200 carbon atoms, (ii) an arylene group having from about 6 carbon atoms to about 200 carbon atoms, (iii) an arylalkylene group having from about 7 carbon atoms to about 200 carbon atoms, or (iv) an alkylarylene group having from about 7 carbon atoms to about 200 carbon atoms and R_{g}, Rₕ, Rⱼ, Rₖ, Rₚ and R_{q} are each independently (i) a hydrogen atom, (ii) an alkyl group having from about 1 carbon atoms to about 200 carbon atoms, (iii) an aryl group having from about 6 carbon atoms to about 200 carbon atoms, (iv) an arylalkyl group having from about 6 carbon atoms to about 200 carbon atoms, or (v) an alkylaryl group having from about 6 carbon atoms to about 200 carbon atoms.

10. The process according to claim 5, wherein the flushing agent comprises a resin and a dispersant,
wherein the dispersant comprises at least one of a bis-urethane and a polyisobutylene succinimide, or a mixture of both.

11. The process according to claim 9, wherein the flushing agent further comprises a bis-urethane resin of the formula 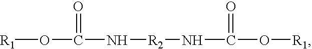
wherein each R₁ is independent of each other (i) an alkyl group having from about 1 carbon atoms to about 200 carbon atoms, (ii) an aryl group having from about 6 carbon atoms to about 200 carbon atoms, (iii) an arylalkyl group having from about 6 carbon atoms to about 200 carbon atoms, or (iv) an alkylaryl group having from about 6 carbon atoms to about 200 carbon atoms; and R₂ is (i) an alkylene group having from about 3 carbon atoms to about 200 carbon atoms, (ii) an arylene group having from about 6 carbon atoms to about 200 carbon atoms, (iii) an arylalkylene group having from about 7 carbon atoms to about 200 carbon atoms, or (iv) an alkylarylene group having from about 7 carbon atoms to about 200 carbon atoms.

12. The process according to claim 1, further comprising filtering the solid inkjet ink after incorporating the pigment dispersion with the one or more ink ingredients.

13. The process according to claim 1, wherein the non-aqueous phase comprises an oligomer or a polymer.

14. The process according to claim 1, wherein the first mixing step is high torque mixing or high shear mixing.

15. The process of according to claim 1, wherein the first mixing step is performed with a high-speed rotor-stator dispersion mill or a sigma blade mixer.

16. The process of according to claim 1, wherein the second mixing step is high shear mixing.

17. The process of according to claim 1, wherein the second mixing step is performed with a high-speed rotor-stator homogenizer.

18. The process according to claim 1, wherein the first mixing step heats the pigment dispersion to about 100° C. to about 150° C.

19. The process according to claim 1, wherein the first mixing step heats the pigment dispersion to about 120° C. to about 140° C.

20. The process according to claim 1, further comprising removing a substantial portion of water before adding the one or more ink ingredients, wherein the water is removed by vaporization, evaporation, decantation, or centrifugation.

21. The process according to claim 1, further comprising removing residual water by applying a vacuum during or after the second mixing step.

22. A process for preparing a solid inkjet ink, comprising
adding one or more ink ingredients directly to a non-aqueous pigment dispersion to form a mixture, and
applying high shear mixing to the mixture to remove volatile content of the non-aqueous pigment dispersion and to form a solid inkjet ink.

23. The process according to claim 22, wherein the ink ingredient is a wax, a colorant, a resin, or combinations thereof.

24. The process according to claim 22, wherein the high shear mixing heats the mixture to about 100° C. to about 150° C.

25. The process according to claim 22, wherein the high shear mixing is performed with a high-speed rotor-stator homogenizer.

26. The process according to claim 22, further comprising removing a substantial portion of residual solvent by applying a vacuum.

27. A method of forming an image, comprising applying the solid inkjet ink prepared by the process of claim 1 to a substrate.
